(19) United States
(12) Patent Application Publication
(10) Pub. No.: US 2025/0385847 A1
(43) Pub. Date: Dec. 18, 2025

(54) METHOD AND APPARATUS FOR TRAFFIC SCHEDULING IMPLEMENTATION, DEVICE, STORAGE MEDIUM, AND PROGRAM PRODUCT

(71) Applicant: Beijing Volcano Engine Technology Co., Ltd., Beijing (CN)

(72) Inventors: Pengli WANG, Beijing (CN); Xiongchun Duan, Beijing (CN); Zhongjun Zhang, Singapore (SG)

(21) Appl. No.: 19/074,225

(22) Filed: Mar. 7, 2025

(30) Foreign Application Priority Data
Jun. 17, 2024 (CN) 202410780710.4

(51) Int. Cl. H04L 41/40; H04L 61/5038

(52) U.S. Cl. CPC H04L 41/40; H04L 61/5038

(57) ABSTRACT

The present disclosure provides a method of traffic scheduling implementation, including: receiving a domain name resolution request sent by a first business application on a first terminal device, and performing domain name resolution on the domain name resolution request to determine a to-be-resolved domain name; if the to-be-resolved domain name is a target domain name, determining, from a preset network segment, a first virtual network address corresponding to the to-be-resolved domain name, and using the first virtual network address as a first traffic destination address corresponding to the to-be-resolved domain name, where the preset network segment includes a plurality of virtual network addresses; and sending the first traffic destination address to the first business application on the first terminal device, to cause the first business application to perform data transmission based on the first traffic destination address.

### CROSS-REFERENCE TO RELATED APPLICATION(S)

This application claims priority to Chinese Application No. 202410780710.4 filed in Jun. 17, 2024, the disclosure of which is incorporated herein by reference in its entity.

### FIELD

The present disclosure relates to the technical field, and in particular, to a method and apparatus for traffic scheduling implementation, a device, a storage medium, and a program product.

### BACKGROUND

A software-defined wide area network (SD-WAN) is a virtual wide area network architecture that allows an enterprise or other organization to use any combination of transmission services to securely connect a user to a business application. One of the core functions of SD-WAN is traffic scheduling. Through an intelligent routing algorithm and a traffic scheduling mechanism, SD-WAN can automatically select an optimal network path based on a real-time network traffic condition, to ensure efficient transmission of network traffic and good performance of the business application.

### SUMMARY

In view of this, the present disclosure provides a method of traffic scheduling implementation and apparatus, a device, a storage medium, and a program product, to solve the problem that data cannot be effectively transmitted in a cross-region transmission process.

According to a first aspect, the present disclosure provides a method of traffic scheduling implementation. The method is applied to a client of a security management application, and the method includes:
receiving a domain name resolution request sent by a first business application on a first terminal device, and performing domain name resolution on the domain name resolution request to determine a to-be-resolved domain name, where the first terminal device is a terminal device on which the client of the security management application is located;
if the to-be-resolved domain name is a target domain name, determining, from a preset network segment, a first virtual network address corresponding to the to-be-resolved domain name, and using the first virtual network address as a first traffic destination address corresponding to the to-be-resolved domain name, where the preset network segment includes a plurality of virtual network addresses; and
sending the first traffic destination address to the first business application on the first terminal device, to cause the first business application to perform data transmission based on the first traffic destination address.

According to a second aspect, the present disclosure provides an apparatus for traffic scheduling implementation. The apparatus is applied to a client of a security management application, and the apparatus includes:
a first processing module, configured to receive a domain name resolution request sent by a first business application on a first terminal device, and perform domain name resolution on the domain name resolution request to determine a to-be-resolved domain name, where the first terminal device is a terminal device on which the client of the security management application is located;
a second processing module, configured to: if the to-be-resolved domain name is a target domain name, determine, from a preset network segment, a first virtual network address corresponding to the to-be-resolved domain name, and use the first virtual network address as a first traffic destination address corresponding to the to-be-resolved domain name, where the preset network segment includes a plurality of virtual network addresses; and
a first sending module, configured to send the first traffic destination address to the first business application on the first terminal device, to cause the first business application to perform data transmission based on the first traffic destination address.

According to a third aspect, the present disclosure provides a computer device. The computer device includes a memory and a processor. The memory and the processor is communicatively connected with each other. The memory stores computer instructions. The processor executes the computer instructions, to perform the method of traffic scheduling implementation according to the first aspect or any implementation of the first aspect.

According to a fourth aspect, the present disclosure provides a computer-readable storage medium. The computer-readable storage medium stores computer instructions. The computer instructions are used to cause a computer to perform the method of traffic scheduling implementation according to the first aspect or any implementation of the first aspect.

According to a fifth aspect, the present disclosure provides a computer program product. The computer program product includes computer instructions. The computer instructions are used to cause a computer to perform the method of traffic scheduling implementation according to the first aspect or any implementation of the first aspect.

### BRIEF DESCRIPTION OF THE DRAWINGS

To describe the technical solutions in the embodiments of the present disclosure or in the prior art more clearly, the following briefly introduces the drawings required for describing the embodiments or the prior art. Apparently, the drawings in the following description show some embodiments of the present disclosure, and a person of ordinary skill in the art may derive other drawings from these drawings without creative efforts.

FIG. 1 is a schematic diagram of an SD-WAN-based network architecture according to an embodiment of the present disclosure;

FIG. 2 is a flowchart of a method of traffic scheduling implementation according to an embodiment of the present disclosure;

FIG. 3 is a flowchart of another method of traffic scheduling implementation according to an embodiment of the present disclosure;

FIG. 4 is a flowchart of another method of traffic scheduling implementation according to an embodiment of the present disclosure;

FIG. 5 is a flowchart of another method of traffic scheduling implementation according to an embodiment of the present disclosure;

FIG. 6 is a flowchart of a method of traffic scheduling implementation according to an embodiment of the present disclosure;

FIG. 7 is a flowchart of another method of traffic scheduling implementation according to an embodiment of the present disclosure;

FIG. 8 is a flowchart of another method of traffic scheduling implementation according to an embodiment of the present disclosure;

FIG. 9 is a flowchart of another method of traffic scheduling implementation according to an embodiment of the present disclosure;

FIG. 10 is a structural block diagram of an apparatus for traffic scheduling implementation according to an embodiment of the present disclosure; and

FIG. 11 is a schematic diagram of a hardware structure of a computer device according to an embodiment of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the protection scope of the present disclosure.

In the description of the embodiments of the present disclosure, the term “include/comprise” and similar terms should be interpreted as open inclusion, that is, “include/comprise but not limited to”. The term “based on” should be understood as “at least partially based on”. The term “one embodiment” or “this embodiment” should be understood as “at least one embodiment”. The term “some embodiments” should be understood as “at least some embodiments”. Other explicit and implicit definitions may also be included below.

In this specification, unless explicitly stated, performing a step “in response to A” does not mean that the step is performed immediately after “A”, but may include one or more intermediate steps.

It can be understood that the data involved in the technical solution (including but not limited to data itself, data acquisition, use, storage or deletion) should comply with the requirements of corresponding laws, regulations and related regulations.

It can be understood that, before using the technical solutions disclosed in the embodiments of the present disclosure, the type, usage scope, usage scenario, or the like of the information involved in the present disclosure should be notified to the related users in an appropriate manner according to the related laws and regulations, and the authorization of the related users should be obtained, where the related users may include any type of rights subject, for example, an individual, an enterprise, or a group.

For example, in response to receiving an active request from a user, prompt information is sent to a related user, to explicitly prompt the related user that an operation requested to be performed will require acquisition and use of information of the related user, so that the related user can independently select, based on the prompt information, whether to provide information to software or hardware, such as an electronic device, an application, a server, or a storage medium, that performs the operation of the technical solution of the present disclosure.

As an optional but non-restrictive implementation, in response to receiving the active request from the related user, the prompt information is sent to the related user in the form of a pop-up window, for example, and the prompt information may be presented in the form of text in the pop-up window. In addition, the pop-up window may carry a selection control for the user to select “agree” or “disagree” to provide information to the electronic device.

It can be understood that the above process of notification and acquisition of user authorization is only illustrative and does not constitute a limitation on the implementations of the present disclosure, and other manners that satisfy the related laws and regulations may also be applied to the implementations of the present disclosure.

Office security usually involves security management of a network, an identity, and a terminal. By implementing private network networking, access control, terminal management in a private network, and information security protection, digital office can be made safer, more efficient, and easier to use. Network-level security management can ensure that a private network such as an office network can run safely and efficiently, thereby ensuring that service data can be transmitted and stored safely. Identity-level security management can improve identity authentication efficiency and security for a user to access the private network. Terminal-level security management can implement unified management of the terminal devices in the private network, data leakage prevention, and terminal threat protection, thereby ensuring security of enterprise data.

In practical applications, security management of the network, the identity, and the terminal can implement technical association in a plurality of technical branches such as networking policy, network admission and control, remote access, unified terminal management, terminal detection and response, enterprise data leakage prevention, and identity authentication management, thereby making digital office simpler, more efficient, and easier to implement.

At present, a traditional wide area network (WAN) architecture does not consider cloud computing. Therefore, when using the traditional WAN architecture, a large organization needs to return traffic of each branch network to a central location or a headquarters data center that applies an advanced security check service for an advanced security check and service. However, a delay caused by the return may affect performance of a business application. In particular, with development of cloud computing technologies, the problem caused by the traditional WAN architecture becomes more and more obvious.

In contrast, a software-defined wide area network (SD-WAN) is a virtual wide area network architecture that allows a large organization to use any combination of transmission services to securely connect a user to a business application. The network architecture of SD-WAN is more flexible. SD-WAN supports hosting an Internet data center within an enterprise, a business application in a public cloud or a private cloud, and a software operation service (SaaS), and can provide higher-level performance of the business application.

One of the core functions of SD-WAN is traffic scheduling. Through an intelligent routing algorithm and a traffic scheduling mechanism, and based on a real-time network traffic condition, SD-WAN can automatically select an optimal network path of an application service and optimize bandwidth utilization. When configuring a device of SD-WAN, an intelligent routing rule and a traffic scheduling priority need to be set, to ensure efficient transmission of network traffic and good performance of a business application.

In related technologies, an enterprise can control a first business application (which refers to a client, for example, a client of an application (Application, App) and/or a client of the World Wide Web (Web)) to connect to a server of the business application through a software service mode (for example, SaaS, Software as a Service) provided by SD-WAN, to obtain required data. When the first business application and the server of the business application are deployed in different regions, the connection with the server to be accessed may be established through a preset virtual private network (VPN), to obtain the required data. However, when there are a large number of VPNs involved in a traffic scheduling process, a case in which a data flow direction is wrong or data loss occurs easily in a data forwarding process, affecting effectiveness of traffic scheduling.

In view of this, according to the embodiments of the present disclosure, a method embodiment of traffic scheduling implementation is provided. It should be noted that the steps shown in the flowcharts in the drawings may be performed in a computer system such as a set of computer-executable instructions, and although the steps are shown in a logical order in the flowcharts, in some cases, the steps shown or described may be performed in an order different from the order herein.

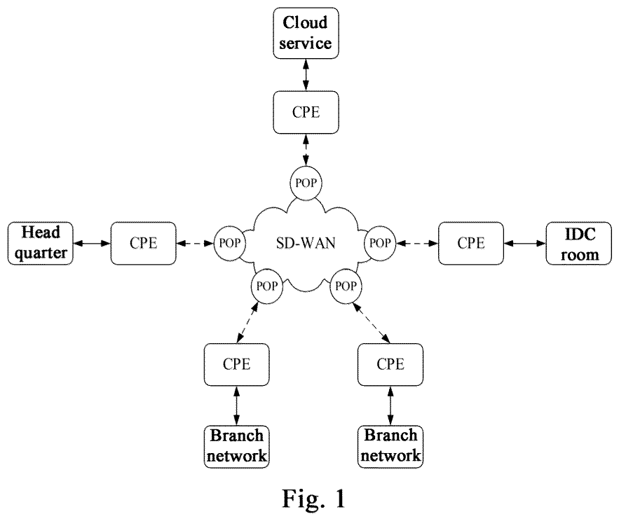

The network architecture based on a software-defined wide area network (abbreviated as SD-WAN) adopted in the embodiments of the present disclosure mainly includes: a client of a security management application for an internal member of an enterprise, a customer-premises equipment (CPE) of SD-WAN, an access point (POP), a central domain name system, and a control plane. Referring to FIG. 1, the components in the network architecture of the present disclosure are used as follows:
(1) The client of the security management application is deployed on terminal devices in an internal network of the enterprise. When an internal member of the enterprise accesses application resources such as a business application hosted in an Internet data center, a public cloud or a private cloud and an SaaS application through a business application client on the terminal device, the client of the security management application performs related traffic scheduling processing based on a server corresponding to each business application (such as an SaaS application and a business application hosted in an Internet data center, a public cloud or a private cloud).
(2) The CPE is deployed at a headquarters of the enterprise, a branch network, an Internet data center (IDC), or a cloud service (such as a public cloud or a private cloud). The CPE, as a branch gateway, is connected to the client of the security management application in an organization/region where the CPE is located, and is configured to converge all proxy traffic (such as traffic of the client of the security management application) in the organization/region.
(3) The POP is connected to the CPE that is physically close to the POP, and the POP is configured to forward traffic converged by the CPE.
(4) The control plane is configured to configure application information, for example, an application name and a domain name of the application. In addition, the control plane is further configured to configure a routing policy corresponding to each application, for example, information for the CPE as an egress gateway corresponding to each application, where the egress gateway is close to a server of the application in terms of geographical location. The control plane delivers configured content to components such as the client of the security management application, the CPE, the POP, and the central domain name system, and performs unified management on all the clients of the security management application, the CPE, the POP, and the central domain name system.
(5) The central domain name system is connected to the client of the security management application and the CPE. The central domain name system is configured to forward, to the corresponding CPE used as an egress gateway, a domain name resolution request of the client of the security management application for a domain name of an application, to obtain a network address of a server corresponding to the domain name of the application through resolution.

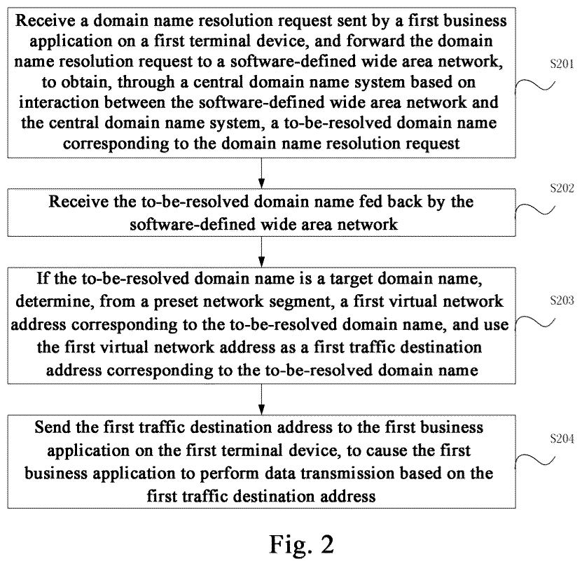

A method of traffic scheduling implementation is provided in this embodiment. The method may be applied to a client of the security management application. FIG. 2 is a flowchart of a method of traffic scheduling implementation according to an embodiment of the present disclosure. As shown in FIG. 2, the method includes the following steps.

Step S201: a domain name resolution request sent by a first business application on a first terminal device is received, and the domain name resolution request is forwarded to a software-defined wide area network, to obtain, through a central domain name system based on interaction between the software-defined wide area network and the central domain name system, a to-be-resolved domain name corresponding to the domain name resolution request.

The first terminal device is a terminal device on which the client of the security management application is located. The first business application may be any business application on the first terminal device. The type of the first business application may include but is not limited to any of the following application types: an office type, a collaborative communication type, a productivity type, and the like. A specific application type may be determined based on an actual service requirement. For example, the office type of business application may be document editing software, a calendar and task management tool, or the like. The collaborative communication type of business application may be an instant messaging application, video conferencing software, or the like. The productivity type of business application may be mind mapping software, a note application, a photographing and file scanning tool, or the like.

The domain name may be understood as a name used for human identification and access to a specific network resource on the Internet, which is convenient for users to remember and use. However, in a network connection process, when the first business application establishes a connection to the server to be accessed, the first business application needs to rely on an Internet Protocol (IP) address corresponding to the domain name. The IP address may be understood as a digital address used for uniquely identifying a device in a computer network.

Therefore, when the domain name resolution request sent by the first business application is received, it represents that the first business application needs to obtain the IP address corresponding to the server to be accessed. Therefore, the obtained domain name resolution request is forwarded to the SD-WAN, so that the domain name resolution request is subjected to domain name resolution by the central domain name system by using interaction between the SD-WAN and the central domain name system, to obtain the to-be-resolved domain name. Therefore, not only the efficiency of domain name resolution can be improved, but also the processing time of the client of the security management application can be saved, and access delay in the traffic scheduling process can be reduced, thereby facilitating the SD-WAN to better manage the network and the first terminal device corresponding to the client of each security management application.

Step S202: the to-be-resolved domain name fed back by the software-defined wide area network is received.

According to the received to-be-resolved domain name, the server to be accessed by the first business application can be determined, and then the traffic destination address to be accessed can be obtained through the to-be-resolved domain name, to establish an effective connection with the server to be accessed, thereby helping to ensure effectiveness of traffic scheduling in the SD-WAN network.

Step S203: if the to-be-resolved domain name is a target domain name, a first virtual network address corresponding to the to-be-resolved domain name is determined from a preset network segment, and the first virtual network address is used as a first traffic destination address corresponding to the to-be-resolved domain name.

The preset network segment in which data processing can be performed in a virtual network is preset for the client of the security management application, to determine which virtual network addresses can access the virtual network. The preset network segment includes a plurality of virtual network addresses. For example, if the preset network segment is xx.xxx.0.0/16, the preset network segment has 65,024 virtual network addresses that can access the virtual network, including xx.xxx.0.1 to xx.xxx.255.254.

To ensure network performance of the virtual network, the target domain name that can allow the virtual network to be used for data processing is preset, so as to limit a terminal that accesses the virtual network by means of the domain name control, to avoid occurrence of excessive access. That is, the target domain name may be understood as a domain name that is predetermined and that can directionally convert a corresponding traffic destination address into the first virtual network address. Preferably, the target domain name may be configured by creating a routing table.

After the to-be-resolved domain name is obtained, to determine whether the to-be-resolved domain name can be directionally converted into the virtual network address, the to-be-resolved domain name is matched with the target domain name. If the to-be-resolved domain name is the target domain name, the first virtual network address corresponding to the to-be-resolved domain name is determined from the preset network segment, and the first virtual network address is used as the first traffic destination address corresponding to the to-be-resolved domain name, so that the first business application can be facilitated to establish a connection to the virtual network through traffic redirection, thereby improving the efficiency of data processing.

Step S204: the first traffic destination address is sent to the first business application on the first terminal device, to cause the first business application to perform data transmission based on the first traffic destination address.

The first traffic destination address is sent to the first business application on the first terminal device, so that the first business application can determine the target IP address to be connected to, so that targeted connection can be conducted in subsequent data transmission, thereby effectively avoiding occurrence of data transmission error or data transmission omission, and helping to ensure effectiveness of traffic scheduling in the SD-WAN network.

According to the method of traffic scheduling implementation provided in this embodiment, in the case where the to-be-resolved domain name is the target domain name, the first virtual network address corresponding to the to-be-resolved domain name is determined from the preset network segment through traffic redirection, and the first virtual network address is sent to the first business application as the first traffic destination address corresponding to the to-be-resolved domain name, so that when accessing the to-be-resolved domain name, the first business application can perform data transmission through the first traffic destination address, thereby ensuring effectiveness of traffic scheduling in the SD-WAN network, reducing network delay, and being beneficial to improvement of network performance.

In some optional implementations, the process of forwarding the domain name resolution request to the software-defined wide area network may include the following steps.
Step a1: a plurality of to-be-scheduled domain names is obtained, where the plurality of to-be-scheduled domain names are encapsulated into a bloom filter, and the bloom filter is used to indicate existence of the plurality of to-be-scheduled domain names.
Step a2: bloom calculation is performed on the target domain name and the bloom filter, to obtain a matching result of the target domain name and the plurality of to-be-scheduled domain names.
Step a3: a scheduling condition of the target domain name is determined based on the matching result.
Step a4: if the target domain name is a to-be-scheduled domain name, the domain name resolution request is forwarded to the software-defined wide area network.

Specifically, the plurality of to-be-scheduled domain names are domain names of the business applications configured by the control plane of the SD-WAN. For each to-be-scheduled domain name, a hash function provided by the bloom filter may be used to map the to-be-scheduled domain name to different positions in a preset bit array in the bloom filter, and values of these positions are set to 1. When it is necessary to query a matching condition of the target domain name and the plurality of to-be-scheduled domain names, the hash function provided by the bloom filter may be used to perform hash mapping (that is, the bloom calculation mentioned above) on the target domain name, to map the target domain name to a position of the preset bit array, and it is checked whether values of these positions are all 1. If the values of all the mapped positions are 1, it indicates that the target domain name exists in the plurality of to-be-scheduled domain names. If the value of any position is 0, it indicates that the target domain name does not exist in the plurality of to-be-scheduled domain names. Therefore, the efficiency of domain name matching can be effectively improved when there is a large amount of data of to-be-scheduled domain names. If the target domain name does not exist in the plurality of to-be-scheduled domain names, it is determined that the scheduling condition of the target domain name is that the target domain name is not a to-be-scheduled domain name. If the target domain name exists in the plurality of to-be-scheduled domain names, it is determined that the scheduling condition of the target domain name is that the target domain name is a to-be-scheduled domain name.

The scheduling condition of the target domain name is used to indicate whether the target domain name needs to be scheduled. Whether the client of the security management application needs to schedule, across a region, traffic corresponding to the target domain name to an egress gateway or a server corresponding to the target domain name may be determined based on a correspondence between a preset domain name and the egress gateway, to obtain the scheduling condition of the target domain name. Exemplarily, assuming that the server corresponding to the target domain name and the client of the security management application are located in a same region, the target domain name may be considered as a domain name that does not need to be scheduled. Assuming that the server corresponding to the target domain name and the client of the security management application are located in different regions, the target domain name may be considered as a domain name that needs to be scheduled.

If the target domain name matches any to-be-scheduled domain name, it is determined that the scheduling condition of the target domain name is that the target domain name is a to-be-scheduled domain name. If the target domain name does not match any to-be-scheduled domain name, it is determined that the scheduling condition of the target domain name is that the target domain name is not a to-be-scheduled domain name.

Therefore, in the case where the target domain name is determined to be the to-be-scheduled domain name, the domain name resolution request is forwarded to the software-defined wide area network, which can effectively improve effectiveness of traffic scheduling in the SD-WAN network.

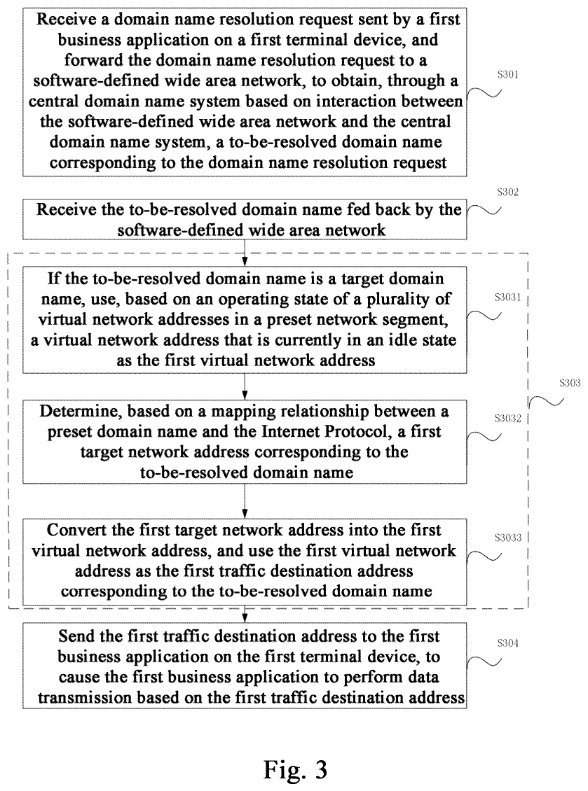

A method of traffic scheduling implementation is provided in this embodiment. The method may be applied to the client of the security management application. FIG. 3 is a flowchart of a method of traffic scheduling implementation according to an embodiment of the present disclosure. As shown in FIG. 3, the method includes the following steps.

Step S301: a domain name resolution request sent by a first business application on a first terminal device is received, and the domain name resolution request is forwarded to a software-defined wide area network, to obtain, through a central domain name system based on interaction between the software-defined wide area network and the central domain name system, a to-be-resolved domain name corresponding to the domain name resolution request. For details, refer to step S201 in the embodiment shown in FIG. 2. Details are not described herein again.

Step S302: the to-be-resolved domain name fed back by the software-defined wide area network is received.

For details, refer to step S202 in the embodiment shown in FIG. 2. Details are not described herein again.

Step S303: if the to-be-resolved domain name is a target domain name, a first virtual network address corresponding to the to-be-resolved domain name is determined from a preset network segment, and the first virtual network address is used as a first traffic destination address corresponding to the to-be-resolved domain name.

Specifically, step S303 includes the following step.

Step S3031: if the to-be-resolved domain name is the target domain name, a virtual network address that is currently in an idle state is used as the first virtual network address based on an operating state of each of a plurality of virtual network addresses in the preset network segment.

In the case where it is determined that the to-be-resolved domain name is the target domain name, the virtual network address that is currently in the idle state in the preset network segment is determined based on the operating states of the plurality of virtual network addresses in the preset network segment.

In some examples, if there is only one virtual network address that is currently in the idle state, the virtual network address that is currently in the idle state is used as the first virtual network address.

In other examples, if there are a plurality of virtual network addresses that are currently in the idle state, the process of determining the first virtual network address includes: determining, based on a network planning sequence of the plurality of virtual network addresses, a plurality of candidate virtual network addresses that are currently in the idle state, and then using a candidate virtual network address with a front-most network planning order in the plurality of candidate virtual network addresses as the first virtual network address. That is, the virtual network address that is currently in the idle state and that has the front-most order is used as the first virtual network address based on the network planning sequence of the plurality of virtual network addresses, so that when the first virtual network address is determined, the efficiency of determining the first virtual network address can be improved, and the possibility of address conflict can be reduced, thereby helping to improve maintainability and reliability of virtual network address allocation. For example, if the plurality of virtual network addresses in the preset network segment are respectively IP1, IP2, and IP3, where IP1 is in an occupied state, and IP2 and IP3 are in the idle state, IP2 is preferentially selected as the first virtual network address based on the network planning sequence.

Step S3032: based on a mapping relationship between a preset domain name and the Internet Protocol, a first target network address corresponding to the to-be-resolved domain name is determined.

To map the to-be-resolved domain name to an available network address, so that the first business application can access and communicate through the address, the mapping relationship between the preset domain name and the Internet Protocol is parsed, to determine the first target network address corresponding to the to-be-resolved domain name.

Step S3033: the first target network address is converted into the first virtual network address, and the first virtual network address is used as the first traffic destination address corresponding to the to-be-resolved domain name.

The to-be-resolved domain name is the target domain name. Therefore, network address translation (NAT) processing is performed on the first target network address, to convert the first target network address into the first virtual network address, and the first virtual network address is used as the first traffic destination address corresponding to the to-be-resolved domain name, so that when performing data access through the to-be-resolved domain name, the first business application can establish a connection with the first virtual network address, to access a network resource or service corresponding to the first virtual network address. For example, if the to-be-resolved domain name is a .com, it may be determined, based on a result of parsing the mapping relationship between the preset domain name and the Internet Protocol, that the first target network address corresponding to a .com is IP1. When the determined first virtual network address is IP11, IP1 is converted into IP11, and IP11 is used as the first traffic destination address corresponding to a .com.

Step S304: the first traffic destination address is sent to the first business application on the first terminal device, to cause the first business application to perform data transmission based on the first traffic destination address. For details, refer to step S204 in the embodiment shown in FIG. 2. Details are not described herein again.

According to the method of traffic scheduling implementation provided in this embodiment, the accuracy and reliability of domain name resolution can be ensured by using the mapping relationship between the preset domain name and the Internet Protocol. In turn, the determined first target network address is converted into the first virtual network address, so that occurrence of accessing a wrong or illegal Internet Protocol website can be avoided, thereby efficiently performing data transmission, improving the speed and efficiency of network access and reducing network delay.

In some optional implementations, before step S303 is performed, the conversion relationship between the first target network address and the first virtual network address is saved, so that when the first business application performs data transmission through the client of the security management application subsequently, the first target network address corresponding to the first virtual network address can be quickly determined, and the traffic scheduling process is simplified, thereby helping to ensure the continuity and reliability of traffic scheduling in the SD-WAN network and improving the efficiency of data access.

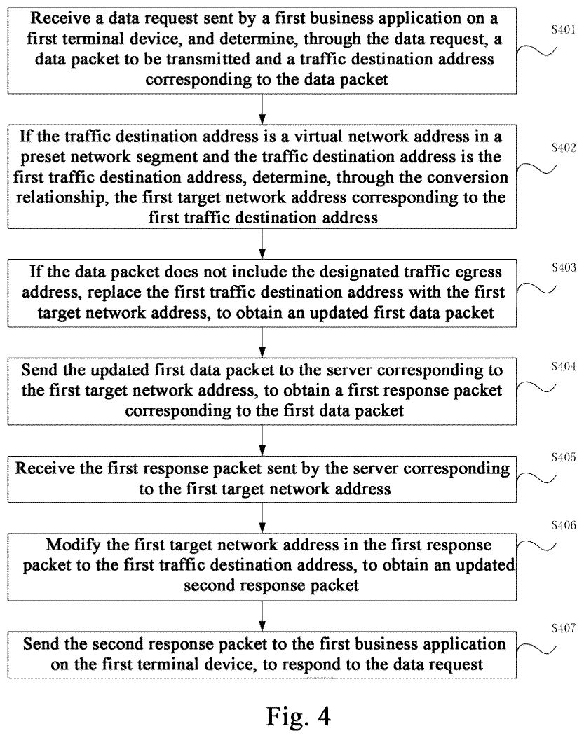

In some other optional implementations, the client of the security management application may forward, based on the saved conversion relationship, the data request sent by the first business application to the corresponding server, so that the data required by the first business application can be correctly transmitted back to the first business application, thereby helping to improve network efficiency and performance. FIG. 4 shows the forwarding process of the data request. FIG. 4 is a flowchart of a method of traffic scheduling implementation according to an embodiment of the present invention. The method includes the following steps.

Step S401: a data request sent by the first business application on the first terminal device is received, and a data packet to be transmitted and a traffic destination address corresponding to the data packet are determined through the data request.

To enable the computer device to determine the data to be transmitted by the first business application and the corresponding traffic destination address, the data request is sent to the computer device, to request to establish a data connection with the traffic destination address.

The data packet is a basic unit in a network transmission process, and includes information about traffic scheduling, such as a source address, a destination address, and data content. In network communication, information in the data request is usually divided into one or more data packets, and transmitted to the destination address through the network.

Therefore, after receiving the data request sent by the first business application, the client of the security management application can determine, by parsing the data request, the data packet to be transmitted and the traffic destination address corresponding to the data packet. The traffic destination address may be understood as a destination address to which the first business application needs to transmit data.

Step S402: if the traffic destination address is a virtual network address in the preset network segment and the traffic destination address is the first traffic destination address, the first target network address corresponding to the first traffic destination address is determined through the conversion relationship.

The virtual network address in the preset network segment can only be accessed in the corresponding virtual network. Therefore, to determine whether the first business application can directly access the traffic destination address to perform data transmission, whether the traffic destination address is a virtual network address in the preset network segment is determined. If the traffic destination address is a virtual network address in the preset network segment and the traffic destination address is the first traffic destination address, the first target network address corresponding to the first traffic destination address is determined based on the conversion relationship stored in advance, so that the client of the security management application can determine the Internet address to which the first business application actually wants to transmit data.

Step S403: if the data packet does not include the designated traffic egress address, the first traffic destination address is replaced with the first target network address, to obtain an updated first data packet.

Whether the data packet includes the designated traffic egress address is determined. If the data packet does not include the designated traffic egress address, it represents that the data packet does not need to be forwarded to another computer device through traffic forwarding. Therefore, the first traffic destination address in the data packet may be replaced with the first target network address, to update the data packet, to obtain the updated first data packet, thereby ensuring that the data packet corresponding to the data request can be sent to the correct destination address.

Step S404: the updated first data packet is sent to the server corresponding to the first target network address, to obtain a first response packet corresponding to the first data packet.

The updated first data packet is sent to the server corresponding to the first target network address, so that the server corresponding to the traffic destination address can perform targeted data processing based on the received first data packet, thereby obtaining the first response packet corresponding to the first data packet.

In some optional implementations, step S404 includes the following steps.
Step b1: a target access point corresponding to a target egress gateway is determined.
Step b2: the updated first data packet is sent to the target egress gateway based on the target access point and the first target network address.

It should be noted that a plurality of access points is set in the SD-WAN, and each access point corresponds to one or more egress gateways. In actual operation, the correspondence between each egress gateway and the access point may be obtained, to query the target access point corresponding to the target egress gateway. The target egress gateway is configured to send the first data packet to the server corresponding to the first target network address.

The first data packet is sent to the target egress gateway through the target access point corresponding to the target egress gateway. Therefore, a data flow of the first data packet can be controlled by using the target access point, to improve the accuracy of data transmission.

According to the method of traffic scheduling implementation provided in this embodiment, in the case where the first target network address corresponding to the domain name is not configured, it can be ensured that the data packet corresponding to the data request can be correctly transmitted to the effective destination address, which can not only effectively reduce the configuration cost of the client of the security management application, but also ensure effectiveness of traffic scheduling, thereby effectively avoiding occurrence of accessing a wrong or illegal Internet Protocol website and improving the speed and efficiency of network access.

In some optional implementations, the method further includes the following step.
Step S405: the first response packet sent by the server corresponding to the first target network address is received.

The first response packet is generated by the server corresponding to the first target network address after receiving the first data packet and in response after determining the request content of the data request sent by the first business application.

When the first response packet is received, it represents that the server corresponding to the first target network address has performed targeted response to the data request, and the traffic of the server corresponding to the first target network address is successfully obtained.

Step S406: the first target network address in the first response packet is modified to the first traffic destination address, to obtain an updated second response packet.

To ensure that the response from the server corresponding to the first target network address can be effectively received by the first business application, the first target network address in the first response packet is modified to the first traffic destination address, thereby obtaining the updated second response packet.

Step S407: the second response packet is sent to the first business application on the first terminal device, to respond to the data request.

According to the method of traffic scheduling implementation provided in this embodiment, in the case where the first target network address corresponding to the domain name is not configured, the connection between the first business application and the server corresponding to the first target network address is established through website conversion, which can effectively avoid occurrence of accessing a wrong or illegal Internet Protocol website and improve the speed and efficiency of network access.

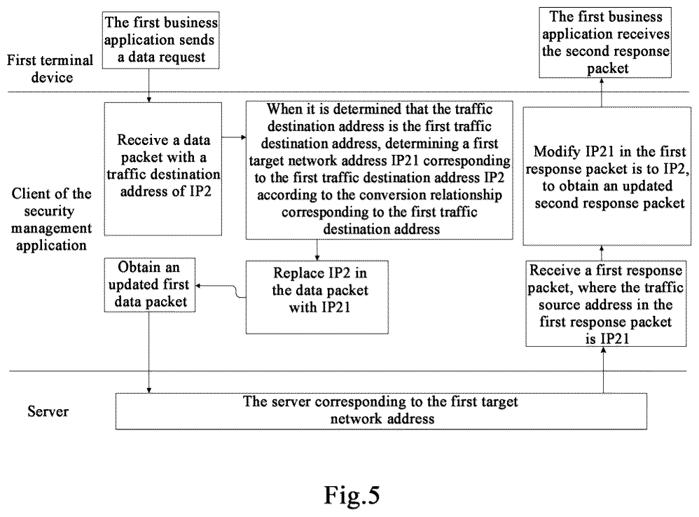

In some optional implementation scenarios, as shown in FIG. 5, when the first business application on the first terminal device needs to perform data access, the data request is sent to the client of the security management application. The data request includes a traffic source address of the target device and a traffic destination address of the target device. For example, in the data packet, the traffic source address is IP1, and the traffic destination address is IP2. When it is determined that the traffic destination address is a virtual network address in the preset network segment and the traffic destination address is the first traffic destination address, the first target network address IP21 corresponding to the first traffic destination address IP2 is determined through the conversion relationship corresponding to the first traffic destination address. In the case where the data packet does not include the designated traffic egress address, IP2 in the data packet is replaced with IP21, thereby obtaining the updated first data packet. That is, in the first data packet, the traffic source address is IP1, and the target IP address is IP21. The first data packet is sent to the server corresponding to the first target network address, to obtain the first response packet.

The server corresponding to the first target network address returns the generated first response packet to the client of the security management application. The traffic source address in the first response packet is IP21. Therefore, to ensure that the response from the server corresponding to the first target network address can be effectively received by the first business application, IP21 in the first response packet is modified to IP2, thereby obtaining the updated second response packet. That is, in the second response packet, the traffic source address is IP2, and the target IP address is IP1. The second response packet is sent to the first business application on the first terminal device, to respond to the data request, thereby implementing traffic scheduling between the first business application and the server corresponding to the first target network address.

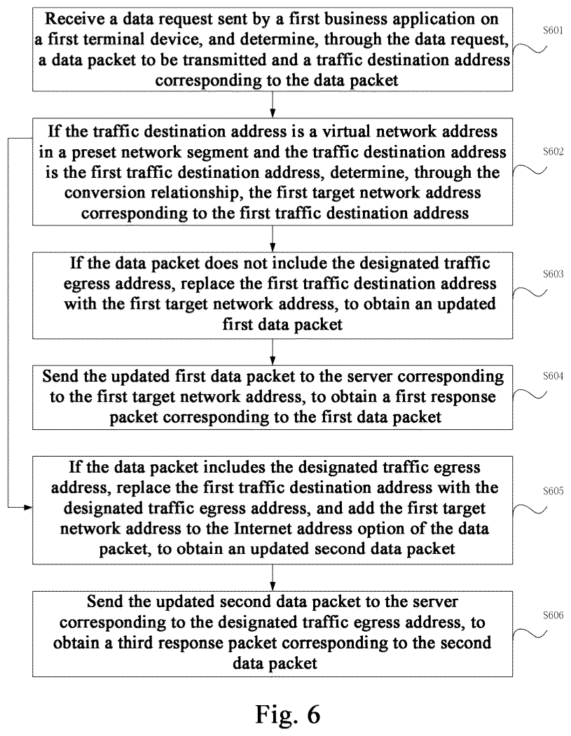

A method of traffic scheduling implementation is provided in this embodiment. The method may be applied to the client of the security management application. FIG. 6 is a flowchart of a method of traffic scheduling implementation according to an embodiment of the present disclosure. As shown in FIG. 6, the method includes the following steps.

Step S601: a data request sent by the first business application on the first terminal device is received, and a data packet to be transmitted and a traffic destination address corresponding to the data packet are determined through the data request.

Step S602: if the traffic destination address is a virtual network address in the preset network segment and the traffic destination address is the first traffic destination address, the first target network address corresponding to the first traffic destination address is determined through the conversion relationship.

Step S603: if the data packet does not include the designated traffic egress address, the first traffic destination address is replaced with the first target network address, to obtain an updated first data packet.

Step S604: the updated first data packet is sent to the server corresponding to the first target network address, to obtain a first response packet corresponding to the first data packet.

Step S605: if the data packet includes the designated traffic egress address, the first traffic destination address is replaced with the designated traffic egress address, and the first target network address is added to an Internet address option of the data packet, to obtain an updated second data packet.

If the data packet includes the designated traffic egress address, it represents that the data packet needs to be forwarded to another client of the security management application through traffic forwarding. The Internet address option field in the data packet format is a custom field. Therefore, to enable the client of the security management application along the transmission path to determine the traffic transmission direction of the data packet and the final destination address based on the received data packet in the data packet transmission process, the first traffic destination address is replaced with the designated traffic egress address, and the first target network address is added to the Internet address option of the data packet, so that the data request can be effectively transmitted to the destination address without changing the data packet format, thereby obtaining the updated second data packet.

Step S606: the updated second data packet is sent to the server corresponding to the designated traffic egress address, to obtain a third response packet corresponding to the second data packet.

According to the method of traffic scheduling implementation provided in this embodiment, in a data packet forwarding process, the first traffic destination address in the data packet is replaced with the designated traffic egress address, and the first target network address is added to the Internet address option of the data packet, which can enable the clients of the security management application along the transmission path to determine the traffic transmission direction of the data packet and the final destination address based on the received data packet without pre-configuring other clients of the security management application, thereby ensuring the continuity and reliability of traffic scheduling in the SD-WAN network and improving the efficiency of data access.

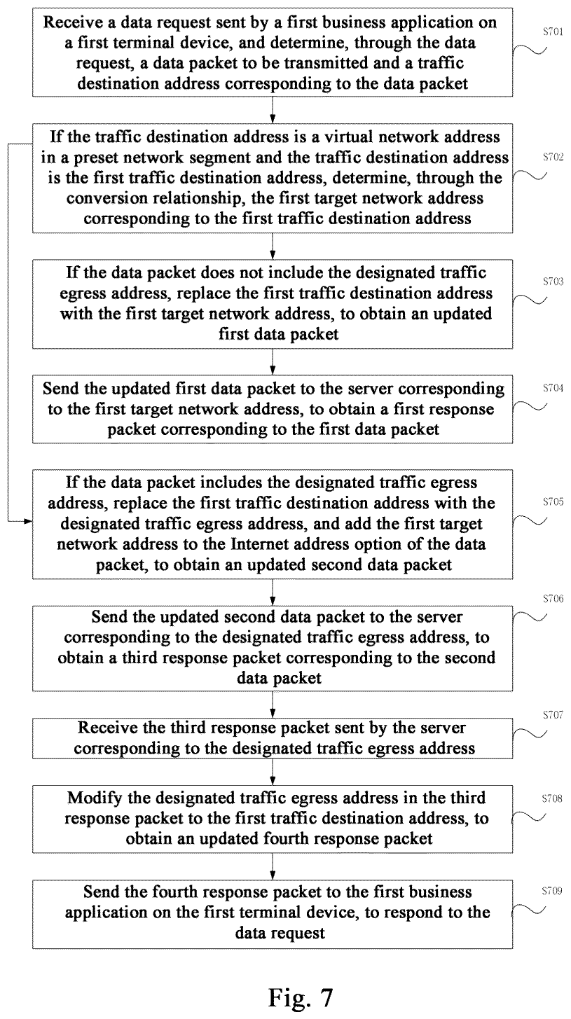

A method of traffic scheduling implementation is provided in this embodiment. The method may be applied to the client of the security management application. FIG. 7 is a flowchart of a method of traffic scheduling implementation according to an embodiment of the present disclosure. As shown in FIG. 7, the method includes the following steps.

Step S701: a data request sent by the first business application on the first terminal device is received, and a data packet to be transmitted and a traffic destination address corresponding to the data packet are determined through the data request.

Step S702: if the traffic destination address is a virtual network address in the preset network segment and the traffic destination address is the first traffic destination address, the first target network address corresponding to the first traffic destination address is determined through the conversion relationship.

Step S703: if the data packet does not include the designated traffic egress address, the first traffic destination address is replaced with the first target network address, to obtain an updated first data packet.

Step S704: the updated first data packet is sent to the server corresponding to the first target network address, to obtain a first response packet corresponding to the first data packet.

Step S705: if the data packet includes the designated traffic egress address, the first traffic destination address is replaced with the designated traffic egress address, and the first target network address is added to the Internet address option of the data packet, to obtain an updated second data packet.

Step S706: the updated second data packet is sent to the server corresponding to the designated traffic egress address, to obtain a third response packet corresponding to the second data packet.

Step S707: the third response packet sent by the server corresponding to the designated traffic egress address is received.

The third response packet is generated by the server corresponding to the designated traffic egress address after receiving the second data packet and in response after determining the request content of the data request sent by the first business application.

When the third response packet is received, it represents that the server corresponding to the designated traffic egress address has performed targeted response to the data request, and the traffic of the server corresponding to the designated traffic egress address is successfully obtained.

Step S708: the designated traffic egress address in the third response packet is modified to the first traffic destination address, to obtain an updated fourth response packet.

To ensure that the response from the server corresponding to the designated traffic egress address can be effectively received by the first business application, the first target network address in the third response packet is modified to the first traffic destination address, thereby obtaining the updated fourth response packet.

Step S709: the fourth response packet is sent to the first business application on the first terminal device, to respond to the data request.

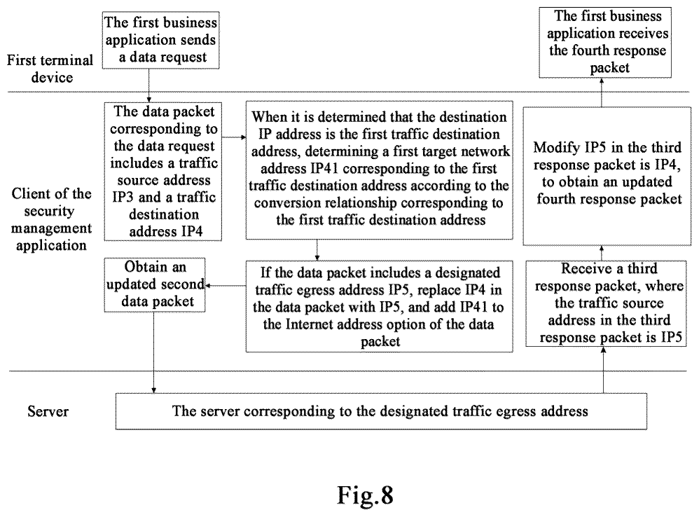

According to the method of traffic scheduling implementation provided in this embodiment, in the case where the first target network address corresponding to the domain name is not configured, the clients of the security management application along the transmission can determine the traffic transmission direction of the data packet and the final destination address based on the received data packet, thereby promoting the first business application to transmit data to the Internet Protocol website that needs to be accessed, thereby not only ensuring the continuity and reliability of traffic scheduling in the SD-WAN network, but also helping to improve the efficiency of data access. In some optional implementation scenarios, as shown in FIG. 8, when the first business application on the first terminal device needs to perform data access, the data request is sent to the client of the security management application. The data request includes a traffic source address of the target device and a traffic destination address of the target device. For example, the data packet corresponding to the data request includes a traffic source address of IP3 and a destination IP address of IP4. When it is determined that the destination IP address is a virtual network address in the preset network segment and the destination IP address is the first traffic destination address, the first target network address IP41 corresponding to the first traffic destination address is determined through the conversion relationship corresponding to the first traffic destination address. If the data packet includes the designated traffic egress address IP5, IP4 in the data packet is replaced with IP5, and IP41 is added to the Internet address option of the data packet, thereby obtaining the updated second data packet. That is, in the second data packet, the traffic source address is IP3, the destination IP address is IP5, and the Internet address option (IP Option) is IP41. The second data packet is sent to the server corresponding to the designated traffic egress address, to obtain the third response packet.

The server corresponding to the designated traffic egress address returns the generated third response packet to the client of the security management application. The traffic source address in the third response packet is IP5. Therefore, to ensure that the response from the server corresponding to the designated traffic egress address can be effectively received by the first business application, IP5 in the third response packet is modified to IP4, thereby obtaining the updated fourth response packet. That is, in the fourth response packet, the traffic source address is IP4, and the target IP address is IP3. The fourth response packet is sent to the first business application on the first terminal device, to respond to the data request, thereby implementing traffic scheduling between the first business application and the server corresponding to the designated traffic egress address.

In some optional implementations, if the traffic destination address is not a virtual network address in the preset network segment, it is determined that the traffic destination address is a public Internet access address. Therefore, the data packet may be directly sent to the server corresponding to the traffic destination address, to obtain a response packet corresponding to the data packet. The response packet corresponding to the data packet sent by the server corresponding to the traffic destination address is received, and the response packet corresponding to the data packet is sent to the first business application on the first terminal device, to respond to the data request, thereby implementing communication transmission between the first business application and the traffic destination address.

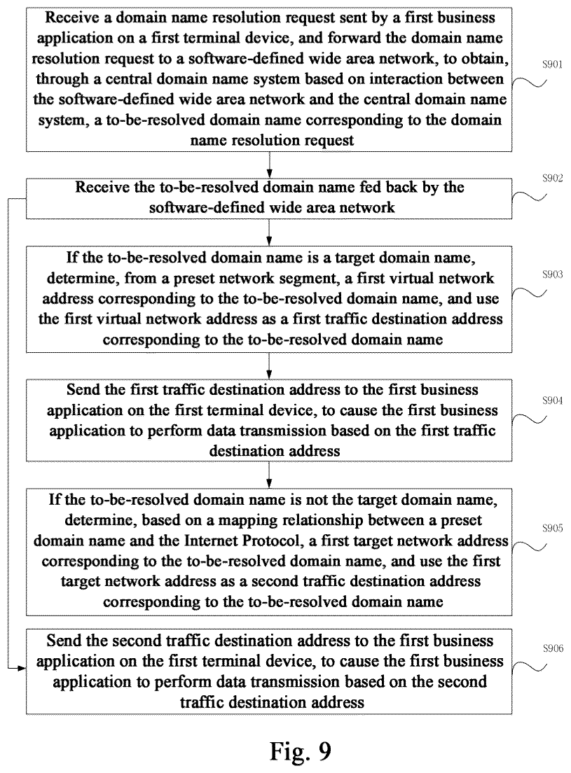

A method of traffic scheduling implementation is provided in this embodiment. The method may be applied to the client of the security management application. FIG. 9 is a flowchart of a method of traffic scheduling implementation according to an embodiment of the present disclosure. As shown in FIG. 9, the method includes the following steps.

Step S901: a domain name resolution request sent by a first business application on a first terminal device is received, and the domain name resolution request is forwarded to a software-defined wide area network, to obtain, through a central domain name system based on interaction between the software-defined wide area network and the central domain name system, a to-be-resolved domain name corresponding to the domain name resolution request.

Step S902: the to-be-resolved domain name fed back by the software-defined wide area network is received.

Step S903: if the to-be-resolved domain name is a target domain name, a first virtual network address corresponding to the to-be-resolved domain name is determined from a preset network segment, and the first virtual network address is used as a first traffic destination address corresponding to the to-be-resolved domain name.

Step S904: the first traffic destination address is sent to the first business application on the first terminal device, to cause the first business application to perform data transmission based on the first traffic destination address.

Step S905: if the to-be-resolved domain name is not the target domain name, a first target network address corresponding to the to-be-resolved domain name is determined based on a mapping relationship between a preset domain name and the Internet Protocol, and the first target network address is used as a second traffic destination address corresponding to the to-be-resolved domain name.

If the to-be-resolved domain name is not the target domain name, it represents that the to-be-resolved domain name cannot be converted into the virtual network address provided by the client of the security management application. Therefore, to ensure effectiveness of traffic scheduling in the SD-WAN network, the mapping relationship between the preset domain name and the Internet Protocol is parsed, to determine the first target network address corresponding to the to-be-resolved domain name, and the first target network address is used as the second traffic destination address corresponding to the to-be-resolved domain name.

Step S906: the second traffic destination address is sent to the first business application on the first terminal device, to cause the first business application to perform data transmission based on the second traffic destination address.

According to the method of traffic scheduling implementation provided in this embodiment, the traffic destination address corresponding to the to-be-resolved domain name is determined through domain name comparison, which can make the traffic scheduling manner more flexible and efficient, thereby making the traffic scheduling manner between the first business application and the domain name to be accessed more convenient, and effectively improving network response performance.

As one or more specific application embodiments of the embodiments of the present disclosure, the first business application sends the domain name resolution request to the client of the security management application. The client of the security management application receives the domain name resolution request sent by the first business application on the first terminal device, and performs domain name resolution on the domain name resolution request, to obtain the to-be-resolved domain name: a .com. The to-be-resolved domain name is matched with the target domain name. If the to-be-resolved domain name is the target domain name, the virtual network address that is currently in the idle state is used as the first virtual network address based on the operating state of the plurality of virtual network addresses in the preset network segment. For example, the first virtual network address may be IP5. The first target network address IP51 corresponding to the to-be-resolved domain name is determined based on the mapping relationship between the preset domain name and the Internet Protocol. IP51 is converted into IP5, and IP5 is used as the first traffic destination address corresponding to a .com. The domain name resolution response packet is created based on the mapping relationship between a .com and IP5, and the domain name resolution response packet is sent to the first business application on the first terminal device, so that the first business application can learn that the IP address corresponding to a .com is IP5, and then can perform subsequent data transmission based on IP5.

In this embodiment, an apparatus for traffic scheduling implementation is further provided. The apparatus is configured to implement the above embodiments and preferred implementations, and details are not described herein again. As used below, the term “module” may be a combination of software and/or hardware that implement a predetermined function. Although the apparatus described in the following embodiments is preferably implemented in software, implementation in hardware or a combination of software and hardware is also possible and contemplated.

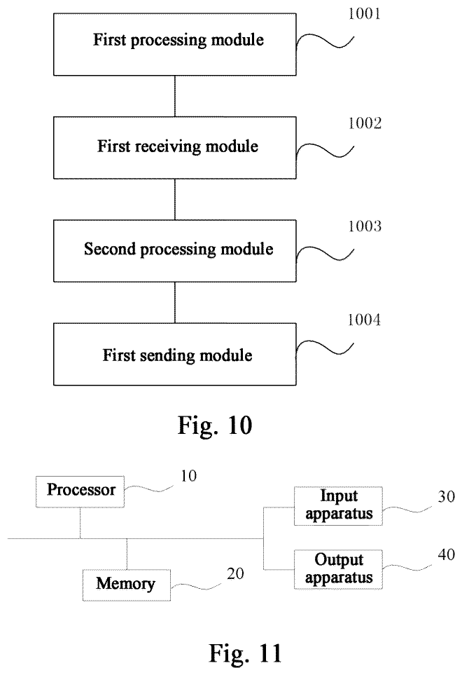

This embodiment provides an apparatus for traffic scheduling implementation. As shown in FIG. 10, the apparatus includes:
a first processing module 1001, configured to receive a domain name resolution request sent by a first business application on a first terminal device, and forward the domain name resolution request to a software-defined wide area network, to obtain, through a central domain name system based on interaction between the software-defined wide area network and the central domain name system, a to-be-resolved domain name corresponding to the domain name resolution request, where the first terminal device is a terminal device on which a client of a security management application is located;
a first receiving module 1002, configured to receive the to-be-resolved domain name fed back by the software-defined wide area network;
a second processing module 1003, configured to: if the to-be-resolved domain name is a target domain name, determine, from a preset network segment, a first virtual network address corresponding to the to-be-resolved domain name, and use the first virtual network address as a first traffic destination address corresponding to the to-be-resolved domain name, where the preset network segment includes a plurality of virtual network addresses; and
a first sending module 1004, configured to send the first traffic destination address to the first business application on the first terminal device, to cause the first business application to perform data transmission based on the first traffic destination address.

In some optional implementations, the second processing module 1103 includes:
a filtering unit, configured to use, based on an operating state of the plurality of virtual network addresses in the preset network segment, a virtual network address that is currently in an idle state as the first virtual network address;
a first determining unit, configured to determine, based on a mapping relationship between a preset domain name and the Internet Protocol, a first target network address corresponding to the to-be-resolved domain name; and
a first converting unit, configured to convert the first target network address into the first virtual network address, and use the first virtual network address as the first traffic destination address corresponding to the to-be-resolved domain name.

In some optional implementations, before the first sending module 1004 sends the first traffic destination address to the first business application on the first terminal device, the apparatus further includes:
a storage unit, configured to save a conversion relationship between the first target network address and the first virtual network address.

In some optional implementations, if there are a plurality of virtual network addresses that are currently in the idle state, the apparatus for determining the first virtual network address includes:
a filtering module, configured to determine, based on a network planning sequence of the plurality of virtual network addresses, a plurality of candidate virtual network addresses that are currently in the idle state; and
a third processing module, configured to use a candidate virtual network address with a front-most network planning order in the plurality of candidate virtual network addresses as the first virtual network address.

In some optional implementations, the apparatus includes:
a second receiving module, configured to receive a data request sent by the first business application on the first terminal device, and determine, based on the data request, a data packet to be transmitted and a traffic destination address corresponding to the data packet;
a fourth processing module, configured to: if the traffic destination address is the virtual network address in the preset network segment and the traffic destination address is the first traffic destination address, determine, through the conversion relationship, the first target network address corresponding to the first traffic destination address;
a first updating module, configured to: if the data packet does not include the designated traffic egress address, replace the first traffic destination address with the first target network address, to obtain an updated first data packet; and
a second sending module, configured to send the updated first data packet to a server corresponding to the first target network address, to obtain a first response packet corresponding to the first data packet.

In some optional implementations, the apparatus further includes:
a third receiving module, configured to receive the first response packet sent by the server corresponding to the first target network address;
a second updating module, configured to modify the first target network address in the first response packet to the first traffic destination address, to obtain an updated second response packet; and
a third sending module, configured to send the second response packet to the first business application on the first terminal device, to respond to the data request.

In some optional implementations, the apparatus further includes:
a third updating module, configured to: if the data packet includes the designated traffic egress address, replace the first traffic destination address with the designated traffic egress address, and add the first target network address to the Internet address option of the data packet, to obtain an updated second data packet; and
a fourth sending module, configured to send the updated second data packet to a server corresponding to the designated traffic egress address, to obtain a third response packet corresponding to the second data packet.

In some optional implementations, the apparatus further includes:
a fourth receiving module, configured to receive the third response packet sent by the server corresponding to the designated traffic egress address;
a fourth updating unit, configured to modify the designated traffic egress address in the third response packet to the first traffic destination address, to obtain an updated fourth response packet; and
a fifth sending module, configured to send the fourth response packet to the first business application on the first terminal device, to respond to the data request.

In some optional implementations, the second sending module includes:
a second determining unit, configured to determine a target access point corresponding to a target egress gateway, where the target egress gateway is configured to send the first data packet to the server corresponding to the first target network address; and
a data packet sending unit, configured to send the updated first data packet to the target egress gateway based on the target access point and the first target network address.

In some optional implementations, the apparatus further includes:
a fifth processing module, configured to: if the to-be-resolved domain name is not the target domain name, determine, based on the mapping relationship between the preset domain name and the Internet Protocol, the first target network address corresponding to the to-be-resolved domain name, and use the first target network address as a second traffic destination address corresponding to the to-be-resolved domain name; and
a sixth sending module, configured to send the second traffic destination address to the first business application on the first terminal device, to cause the first business application to perform data transmission based on the second traffic destination address.

In some optional implementations, the first processing module 1001 includes:
an obtaining unit, configured to obtain a plurality of to-be-scheduled domain names, where the plurality of to-be-scheduled domain names are encapsulated into a bloom filter, and the bloom filter is used to indicate existence of the plurality of to-be-scheduled domain names;
a first processing unit, configured to perform bloom calculation on the target domain name and the bloom filter, to obtain a matching result of the target domain name and the plurality of to-be-scheduled domain names;
a second processing unit, configured to determine a scheduling condition of the target domain name based on the matching result; and
a third processing unit, configured to: if the target domain name is a to-be-scheduled domain name, forward the domain name resolution request to the software-defined wide area network.

For further descriptions of functions of the foregoing modules and units, refer to the corresponding embodiments above. Details are not described herein again.

The apparatus for traffic scheduling implementation in this embodiment is presented in the form of functional units. The unit herein refers to an application-specific integrated circuit (ASIC), a processor and a memory that execute one or more pieces of software or a fixed program, and/or other devices that can provide the foregoing functions.

An embodiment of the present disclosure further provides a computer device, including the apparatus for traffic scheduling implementation shown in FIG. 10.

Please refer to FIG. 11. FIG. 11 is a schematic diagram of a structure of a computer device according to an optional embodiment of the present disclosure. As shown in FIG. 11, the computer device includes: one or more processors 10, a memory 20, and interfaces for connecting components, including a high-speed interface and a low-speed interface. The components communicatively connected with each other by using different buses, and may be installed on a common motherboard or installed in other manners as required. The processor can process instructions executed in the computer device, including instructions stored in or on the memory to display graphical information of a GUI on an external input/output apparatus (such as a display device coupled to the interface). In some optional implementations, if necessary, multiple processors and/or multiple buses may be used together with multiple memories. Similarly, multiple computer devices may be connected, and each device provides part of necessary operations (for example, as a server array, a group of blade servers, or a multi-processor system). FIG. 11 uses one processor 10 as an example.

The processor 10 may be a central processor, a network processor, or a combination thereof. The processor 10 may further include a hardware chip. The hardware chip may be an application-specific integrated circuit, a programmable logic device, or a combination thereof. The programmable logic device may be a complex programmable logic device, a field programmable gate array, a generic array logic, or any combination thereof.

The memory 20 stores instructions executable by at least one processor 10, to cause the at least one processor 10 to implement the method shown in the foregoing embodiments.

The memory 20 may include a program storage region and a data storage region. The program storage region may store an operating system and a business application required for at least one function. The data storage region may store data created based on the use of the computer device. In addition, the memory 20 may include a high-speed random-access memory, and may further include a non-transitory memory, for example, at least one magnetic disk storage device, a flash memory device, or another non-transitory solid-state storage device. In some optional implementations, the memory 20 optionally includes a memory that is remotely provided relative to the processor 10, and the remote memory may be connected to the computer device through a network. An example of the network includes but is not limited to the Internet, an enterprise intranet, a local area network, a mobile communication network, and a combination thereof.

The memory 20 may include a volatile memory, for example, a random-access memory. The memory may also include a non-volatile memory, for example, a flash memory, a hard disk, or a solid-state drive. The memory 20 may further include a combination of the foregoing types of memories.

The computer device further includes an input apparatus 30 and an output apparatus 40. The processor 10, the memory 20, the input apparatus 30, and the output apparatus 40 may be connected through a bus or in another manner. FIG. 11 uses a connection through a bus as an example.

The input apparatus 30 may receive input digital or character information, and generate key signal input related to user settings and function control of the computer device, for example, a touchscreen, a keypad, a mouse, a trackpad, a touchpad, an indicator bar, one or more mouse buttons, a trackball, a joystick, or the like. The output apparatus 40 may include a display device, an auxiliary lighting apparatus (for example, an LED), a tactile feedback apparatus (for example, a vibration motor), and the like. The display device includes but is not limited to a liquid crystal display, a light-emitting diode, a display, and a plasma display. In some optional implementations, the display device may be a touchscreen.

An embodiment of the present disclosure further provides a computer-readable storage medium. The method according to the embodiments of the present disclosure may be implemented in hardware or firmware, or may be implemented as computer code that is recorded in a storage medium or that is downloaded over a network, originally stored in a remote storage medium or a non-transitory machine-readable storage medium, and will be stored in a local storage medium, so that the methods described herein may be stored in such software processing on a storage medium using a general-purpose computer, a dedicated processor, or programmable or dedicated hardware. The storage medium may be a magnetic disk, an optical disc, a read-only memory, a random-access memory, a flash memory, a hard disk, a solid-state drive, or the like. Further, the storage medium may further include a combination of the foregoing types of memories. It may be understood that a computer, a processor, a microprocessor, a controller, or programmable hardware includes a storage component that can store or receive software or computer code, and when the software or computer code is accessed and executed by the computer, the processor, or the hardware, the method shown in the foregoing embodiments is implemented.

A part of the present invention may be applied as a computer program product, for example, computer program instructions. When the computer program instructions are executed by a computer, a method and/or a technical solution according to the present invention may be invoked or provided through the operation of the computer. Those skilled in the art should understand that an existence form of the computer program instructions in a computer-readable medium includes but is not limited to a source file, an executable file, an installation packet file, or the like. Correspondingly, a manner of executing the computer program instructions by the computer includes but is not limited to: directly executing the instructions by the computer, compiling the instructions by the computer and then executing a corresponding compiled program, reading and executing the instructions by the computer, or reading and installing the instructions by the computer and then executing a corresponding post-installation program. Herein, the computer-readable medium may be any available computer-readable storage medium or communication medium accessible by the computer.

It may be understood that before the technical solutions disclosed in the embodiments of the present disclosure are used, the user should be informed and the user's authorization should be obtained in an appropriate manner in accordance with relevant laws and regulations, of types, use scope, use scenarios, and the like, of the personal information involved in the present disclosure.

For example, when receiving an active request from the user, the user is sent prompt information to explicitly prompt the user that the operation requested to be performed will need to acquire and use the user's personal information. Therefore, the user may choose whether to provide personal information to software or hardware, such as a computer device, a business application, a server, or a storage medium, that performs the operation of the technical solution of the present disclosure, based on the prompt information.

As an optional but non-limiting implementation, the manner of sending the prompt information to the user in response to receiving the active request from the user may be, for example, a pop-up window, and the prompt information may be presented in text in the pop-up window. In addition, the pop-up window may further carry a selection control for the user to select “agree” or “disagree” to provide personal information to the computer device.

It may be understood that the preceding notification and user authorization obtaining process is only schematic, and does not limit the implementations of the present disclosure. Other manners that satisfy relevant laws and regulations may also be applied to the implementations of the present disclosure.

Although the embodiments of the present disclosure are described with reference to the drawings, those skilled in the art may make various modifications and variations without departing from the spirit and scope of the present disclosure, and such modifications and variations all fall within the scope defined by the appended claims.

I/We claim:

1. A method of traffic scheduling implementation, applied to a client of a security management application, comprising:
receiving a domain name resolution request sent by a first business application on a first terminal device, and forwarding the domain name resolution request to a software-defined wide area network, to obtain, through a central domain name system based on interaction between the software-defined wide area network and the central domain name system, a to-be-resolved domain name corresponding to the domain name resolution request, the first terminal device being a terminal device on which the client of the security management application is located;
receiving the to-be-resolved domain name fed back by the software-defined wide area network;
in response to the to-be-resolved domain name being a target domain name, determining, from a preset network segment, a first virtual network address corresponding to the to-be-resolved domain name, and using the first virtual network address as a first traffic destination address corresponding to the to-be-resolved domain name, the preset network segment comprising a plurality of virtual network addresses; and
sending the first traffic destination address to the first business application on the first terminal device, to cause the first business application to perform data transmission based on the first traffic destination address.

2. The method of claim 1, wherein determining, from the preset network segment, the first virtual network address corresponding to the to-be-resolved domain name, and using the first virtual network address as the first traffic destination address corresponding to the to-be-resolved domain name comprise:
using, based on an operating state of a plurality of virtual network addresses in the preset network segment, a virtual network address that is currently in an idle state as the first virtual network address;
determining, based on a mapping relationship between a preset domain name and the Internet Protocol, a first target network address corresponding to the to-be-resolved domain name; and
converting the first target network address into the first virtual network address, and using the first virtual network address as the first traffic destination address corresponding to the to-be-resolved domain name.

3. The method of claim 2, wherein in response to there being a plurality of virtual network addresses currently in the idle state, determining the first virtual network address comprises:
determining, based on a network planning sequence of the plurality of virtual network addresses, a plurality of candidate virtual network addresses that are currently in the idle state; and
using a candidate virtual network address with a front-most network planning order in the plurality of candidate virtual network addresses as the first virtual network address.

4. The method of claim 2, wherein before sending the first traffic destination address to the first business application on the first terminal device, the method further comprises:
saving a conversion relationship between the first target network address and the first virtual network address.

5. The method of claim 4, wherein the method further comprises:
receiving a data request sent by the first business application on the first terminal device, and determining, based on the data request, a data packet to be transmitted and a traffic destination address corresponding to the data packet;
in response to the traffic destination address being a virtual network address in the preset network segment and the traffic destination address being the first traffic destination address, determining, through the conversion relationship, the first target network address corresponding to the first traffic destination address;
in response to the data packet not comprising a designated traffic egress address, replacing the first traffic destination address with the first target network address, to obtain an updated first data packet; and
sending the updated first data packet to a server corresponding to the first target network address, to obtain a first response packet corresponding to the first data packet.

6. The method of claim 5, wherein the method further comprises:
receiving the first response packet sent by the server corresponding to the first target network address;
modifying the first target network address in the first response packet to the first traffic destination address, to obtain an updated second response packet; and
sending the second response packet to the first business application on the first terminal device, to respond to the data request.

7. The method of claim 5, wherein the method further comprises:
in response to the data packet comprising the designated traffic egress address, replacing the first traffic destination address with the designated traffic egress address, and adding the first target network address to an Internet address option of the data packet, to obtain an updated second data packet; and
sending the updated second data packet to a server corresponding to the designated traffic egress address, to obtain a third response packet corresponding to the second data packet.

8. The method of claim 7, wherein the method further comprises:
receiving the third response packet sent by the server corresponding to the designated traffic egress address;
modifying the designated traffic egress address in the third response packet to the first traffic destination address, to obtain an updated fourth response packet; and
sending the fourth response packet to the first business application on the first terminal device, to respond to the data request.

9. The method of claim 5, wherein sending the updated first data packet to the server corresponding to the first target network address comprises:
determining a target access point corresponding to a target egress gateway, wherein the target egress gateway is configured to send the first data packet to the server corresponding to the first target network address; and
sending, based on the target access point and the first target network address, the updated first data packet to the target egress gateway.

10. The method of claim 1, wherein the method further comprises:
in response to the to-be-resolved domain name being not the target domain name, determining, based on a mapping relationship between a preset domain name and the Internet Protocol, a first target network address corresponding to the to-be-resolved domain name, and using the first target network address as a second traffic destination address corresponding to the to-be-resolved domain name; and
sending the second traffic destination address to the first business application on the first terminal device, to cause the first business application on the first terminal device to perform data transmission based on the second traffic destination address.

11. The method of claim 1, wherein forwarding the domain name resolution request to the software-defined wide area network comprises:
obtaining a plurality of to-be-scheduled domain names, wherein the plurality of to-be-scheduled domain names are encapsulated into a bloom filter, and the bloom filter is used to indicate existence of the plurality of to-be-scheduled domain names;
performing bloom calculation on the target domain name and the bloom filter, to obtain a matching result of the target domain name and the plurality of to-be-scheduled domain names;
determining, based on the matching result, a scheduling condition of the target domain name; and
in response to the target domain name being a to-be-scheduled domain name, forwarding the domain name resolution request to the software-defined wide area network.

12. A computer device, comprising:
a memory and a processor, wherein the memory and the processor is communicatively connected with each other, the memory stores computer instructions, and the processor executes the computer instructions to receive a domain name resolution request sent by a first business application on a first terminal device, and forward the domain name resolution request to a software-defined wide area network, to obtain, through a central domain name system based on interaction between the software-defined wide area network and the central domain name system, a to-be-resolved domain name corresponding to the domain name resolution request, the first terminal device being a terminal device on which the client of the security management application is located;
receive the to-be-resolved domain name fed back by the software-defined wide area network;
in response to the to-be-resolved domain name being a target domain name, determine, from a preset network segment, a first virtual network address corresponding to the to-be-resolved domain name, and use the first virtual network address as a first traffic destination address corresponding to the to-be-resolved domain name, the preset network segment comprising a plurality of virtual network addresses; and
send the first traffic destination address to the first business application on the first terminal device, to cause the first business application to perform data transmission based on the first traffic destination address.

13. The method of claim 12, wherein when determining, from the preset network segment, the first virtual network address corresponding to the to-be-resolved domain name, and using the first virtual network address as the first traffic destination address corresponding to the to-be-resolved domain name, the processor is to:
use, based on an operating state of a plurality of virtual network addresses in the preset network segment, a virtual network address that is currently in an idle state as the first virtual network address;
determine, based on a mapping relationship between a preset domain name and the Internet Protocol, a first target network address corresponding to the to-be-resolved domain name; and
convert the first target network address into the first virtual network address, and use the first virtual network address as the first traffic destination address corresponding to the to-be-resolved domain name.

14. The computer device of claim 13, wherein when determining the first virtual network address in response to there being a plurality of virtual network addresses currently in the idle state, the processor is to:
determine, based on a network planning sequence of the plurality of virtual network addresses, a plurality of candidate virtual network addresses that are currently in the idle state; and
use a candidate virtual network address with a front-most network planning order in the plurality of candidate virtual network addresses as the first virtual network address.

15. The computer device of claim 13, wherein before sending the first traffic destination address to the first business application on the first terminal device, the processor executes the computer instructions to further:
save a conversion relationship between the first target network address and the first virtual network address.

16. The computer device of claim 15, wherein the processor executes the computer instructions to further:
receive a data request sent by the first business application on the first terminal device, and determine, based on the data request, a data packet to be transmitted and a traffic destination address corresponding to the data packet;
in response to the traffic destination address being a virtual network address in the preset network segment and the traffic destination address being the first traffic destination address, determine, through the conversion relationship, the first target network address corresponding to the first traffic destination address;
in response to the data packet not comprising a designated traffic egress address, replace the first traffic destination address with the first target network address, to obtain an updated first data packet; and
send the updated first data packet to a server corresponding to the first target network address, to obtain a first response packet corresponding to the first data packet.

17. The computer device of claim 16, wherein the processor executes the computer instructions to further:
receive the first response packet sent by the server corresponding to the first target network address;
modify the first target network address in the first response packet to the first traffic destination address, to obtain an updated second response packet; and
send the second response packet to the first business application on the first terminal device, to respond to the data request.

18. The computer device of claim 16, wherein the processor executes the computer instructions to further:
in response to the data packet comprising the designated traffic egress address, replace the first traffic destination address with the designated traffic egress address, and add the first target network address to an Internet address option of the data packet, to obtain an updated second data packet; and
send the updated second data packet to a server corresponding to the designated traffic egress address, to obtain a third response packet corresponding to the second data packet.

19. The computer device of claim 18, wherein the processor executes the computer instructions to further:
receive the third response packet sent by the server corresponding to the designated traffic egress address;
modify the designated traffic egress address in the third response packet to the first traffic destination address, to obtain an updated fourth response packet; and
send the fourth response packet to the first business application on the first terminal device, to respond to the data request.

20. A non-transitory computer-readable storage medium, storing computer instructions which, when executed by a computer, cause the computer to:
receive a domain name resolution request sent by a first business application on a first terminal device, and forward the domain name resolution request to a software-defined wide area network, to obtain, through a central domain name system based on interaction between the software-defined wide area network and the central domain name system, a to-be-resolved domain name corresponding to the domain name resolution request, the first terminal device being a terminal device on which the client of the security management application is located;
receive the to-be-resolved domain name fed back by the software-defined wide area network;
in response to the to-be-resolved domain name being a target domain name, determine, from a preset network segment, a first virtual network address corresponding to the to-be-resolved domain name, and use the first virtual network address as a first traffic destination address corresponding to the to-be-resolved domain name, the preset network segment comprising a plurality of virtual network addresses; and
send the first traffic destination address to the first business application on the first terminal device, to cause the first business application to perform data transmission based on the first traffic destination address.
